(19) United States
(12) Patent Application Publication
(10) Pub. No.: US 2016/0377474 A1
(43) Pub. Date: Dec. 29, 2016

(54) WIRELESS OIL TANK LEVEL REPORTING DEVICE, SYSTEM AND METHOD

(71) Applicants: Arnold Stillman, Huntington, NY (US); Thomas Canino, Fort Salonga, NY (US)

(72) Inventors: Arnold Stillman, Huntington, NY (US); Thomas Canino, Fort Salonga, NY (US)

(21) Appl. No.: 15/196,758

(22) Filed: Jun. 29, 2016

Related U.S. Application Data
(60) Provisional application No. 62/186,124, filed on Jun. 29, 2015.

(51) Int. Cl. G01F 23/62; G08B 21/18

(52) U.S. Cl. CPC G01F 23/62; G08B 21/182

(57) ABSTRACT

A remote level sensor for a residential fuel oil tank is adapted for a fuel oil gauge with a permanent magnet which changes position with changing fluid levels in the tank. The sensor and gauge cylinder are integral so as to align with a magnet on the indicator of the gauge. The sensor is connected a remote monitoring website on the internet by means of a radio connection to a local area network. The sensor has multiple magnetic sensors each in a different relative position. The sensors detect the position of the magnet when the magnet is within a certain distance. Several sensors may detect the magnet and each sensor's output will be proportional to the magnet's distance from it. Two or three sensor outputs are sufficient to interpolate the absolute position of the magnet and thus the fuel oil level in the tank. The controller has a scanning routine that samples the sensor outputs periodically and formats the data into an HTTP POST or PUT message. The controller then send this data and a UUID identifier and MAC address to a remote website.

### CROSS-REFERENCE TO RELATED APPLICATIONS

The present application claims benefit of and priority to U.S. Provisional Patent Application Ser. No. 62/186,124 entitled WIRELESS OIL TANK LEVEL REPORTING DEVICE, SYSTEM AND METHOD filed Jun. 29, 2015, the entire content of which is hereby incorporated by reference herein.

### BACKGROUND

Field of the Disclosure

This present disclosure relates to a fuel oil level reporting system in which each of a plurality of remote fuel oil level sensors monitors the absolute level of fuel oil in a particular oil tank and sends periodic information to a central location for monitoring and analysis.

Related Art

Fuel oil which is used to heat residences and buildings is generally stored in tanks located either inside the building, outside the building or in the ground near the building. In order to ensure that an adequate supply of fuel is available to the building furnace, each tank must be periodically refilled by making a fuel oil delivery to the tank location. Such fuel oil deliveries are presently made by a central distributor utilizing tank trucks.

A problem exists in this supply system in that the oil tanks must be filled before the supply of fuel runs out, but predicting the rate of consumption is difficult. It is not economical for the fuel oil distributor to refill the tanks on a set schedule, especially during the warmer seasons in which fuel oil consumption is at a minimum. Accordingly, fuel oil distributors may schedule a delivery to a particular tank based on a usage history for that tank and recent weather conditions. This type of delivery is referred to as a “degree-day” system, and uses mathematical algorithms to predict the rate of fuel oil consumption for each tank.

Because of variations in usage patterns from one location to another, predictive algorithms for determining when to make a delivery tend to be imprecise. For this reason, a number of prior art systems have been used which automatically monitor the level of oil in a tank, and communicate information regarding the oil level to a central receiving station, generally by means of a direct dial telephone network. In the central receiving station, the information is processed and a report is generated so that a delivery of fuel oil can be scheduled to replenish the customer's supply before it runs out.

In a second type, a sensor/signaling unit at each remote location monitors the fluid level in the oil tank and initiates a telephone call to the central location when a low fuel condition is detected in the tank which it monitors. These systems may include a means for testing the status of the phone line (which is typically also used by the residents for normal telephone service) so that the line is seized by the device only when there is no existing call detected on the line. Examples of such systems are shown in U.S. Pat. Nos. 3,588,357; 3,842,208; 4,059,727 and 4,486,625.

Because it is not uncommon for the monitoring system of a single distributor to include several hundred remote units, it is desirable to make each of the remote units as inexpensive and simple to install as possible. Some methods of reducing the overall cost of the remote sensing units include use of an inexpensive fuel level sensor, an inexpensive mechanism to transmit information to the central location over the telephone network and a construction which allows the unit to be easily and quickly installed.

These problems were addressed to some degree by U.S. Pat. No. 4,845,486. This patent teaches a manner of encoding information for transmission by the remote unit which does not require an expensive, highly stable oscillator. It also teaches the use of a battery so that no external power supply connections are required. Furthermore, this patent describes the use of a reed switch within a sensor used by the remote unit. The sensor clips to a gauge common in many residential fuel oil tanks, and the reed switch is activated by a magnet positioned on a level indicator which moves within the gauge when the oil level changes.

However, battery-powered remote units that use telephone lines for communication require frequent battery changes. U.S. Pat. No. 5,619,560 teaches the use of a secondary power supply to wake the sensor from a quiescent mode. The telephone lines themselves provide power to the secondary lines.

Fluid level determinations in oil tanks were measured with a plurality of reed switches in U.S. Pat. No. 5,619,560. These measurements transmit discrete levels corresponding to the mounting positions of the reed switches. This coarse resolution does not allow precise level determination.

Using the telephone system to transmit level information incurs a cost for each call and an effort to identify the particular tank given the telephone number initiating the call. Identifying a tank that needs refueling would necessitate a reverse lookup of the phone number as the call proceeds or a lookup in a list of numbers after perusing a call log. It also transmits transient data that is not amenable to storage for tracking and prediction of usage. The timing of the phone calls is not very predictable since they only occur at given set-points of the oil levels. There is no ability to automatically chart usage or schedule readings of arbitrary fuel levels.

Accordingly, it would be beneficial to provide an oil level sensor system that avoids these and other problems.

### SUMMARY

It is an object of the present invention to provide constant monitoring of fuel oil levels and consumption as well as continuous resolution of fuel oil levels. It further provides for identifying a particular tank with a unique identifier for automatic lookup in a database. It further provides wireless automatic communication of finely resolved fuel levels to suppliers via the internet and worldwide-web. It further provides for display of fuel oil levels on a web page for perusal on demand by supplier and consumer. It further provides for automatic connection between suppliers and consumers. It further provides communication of predetermined levels by automated phone calls, if desired.

In order to increase the efficiency of scheduling oil deliveries, the sensor device, system and method of the present disclosure monitor the fuel oil level in a tank until the level drops to some preset low level. This low level set-point allows deliveries of a given amount to be made, with the given amount being the empty volume of the tank. Delivering a set number of large amounts is a more efficient use of delivery resources than delivering many smaller amounts of oil.

Presently, the empty volume in a tank is estimated by methods such as degree-day or K-factor calculations. Knowledge of the precise level in a tank removes the process of estimation and replaces it with direct knowledge of deliverable amounts. For multiple deliveries from a single oil delivery truck, many such precise amounts may be arranged to be equivalent to the full capacity of the truck, thereby allowing it to deliver its full volume of oil and return empty. The invention includes an internet-connected fuel tank gauge with fuel level resolution sufficient to implement such a delivery plan. The invention also includes level calculation and notification services provided by a website hosting the connection to the fuel gauge.

A remote level sensor system for a fuel oil tank including a gauge with a permanent magnet that changes position based on a fuel oil level in the fuel oil tank in accordance with an embodiment of the present disclosure includes a housing separate from the gauge and attached thereto, a plurality of magnetic sensors mounted on the gauge, each magnetic sensor of the plurality of magnetic sensors positioned at predetermined position on the gauge relative to the other magnetic sensors of the plurality of sensors and configured to provide information indicating magnetic field at the respective location thereof, a controller connected to each magnetic sensor of the plurality of magnetic sensors and configured to receive information regarding the magnetic field from each of the plurality of magnetic sensors and to generate a unique identifier for each one of the plurality of magnetic sensors, a transmitter connected to the controller and configured to send the information regarding the magnetic field from each of the plurality of magnetic sensors with the unique identifier for the respective magnetic sensor; and a processor that receives the data from the transmitter and determines a position of the permanent magnet on the gauge and provides an indication of the remaining fuel oil in the tank based thereon.

A remote level sensor system for a fuel oil tank including a gauge with a permanent magnet which changes positions along a first axis with changes in the level of oil in the tank in accordance with an embodiment of the present disclosure includes a housing separate from the gauge which attaches securely to the gauge, a plurality of magnetic sensors located in the housing, each magnetic sensor of the plurality of magnetic sensors positioned at predetermined position relative to the gauge and generating continuous voltages under the influence of a magnetic field from the permanent magnet when the magnet is within the sensitivity range of a particular magnetic sensor of subset of the plurality of magnetic sensors, a controller connected to the plurality of magnetic sensors receiving the continuous voltage information and generating a unique identifier for each magnetic sensor as well as digital data based on the continuous voltage information and the unique identified associated with the and including a web server running on the controller providing for initialization and configuration of controller parameters and a transmitter connected to the controller and configured to transmit the digital data including the unique identifier associated therewith to a local area network and thence to a processor of a remote website wherein the processor determines a position of the permanent magnet based on the digital data and the unique identifier to estimate the magnet position with respect to the magnetic sensor positions.

A remote level sensor system for a fuel oil tank including a gauge with a permanent magnet which changes positions along a first axis with changes in the level of oil in the tank in accordance with an embodiment of the present disclosure includes a housing separate from the gauge which slips over the gauge, the housing including a cylindrical hole through which the gauge passes, a plurality of magnetic sensors located in the housing each magnetic sensor of the plurality of magnetic sensors positioned at predetermined position relative to the gauge and generating continuous voltages under the influence of a magnetic field from the permanent magnet when the magnet is within the sensitivity range of a particular magnetic sensor of subset of the plurality of magnetic sensors, a controller for generating a unique identifier and digital data from analog voltage outputs of each of the magnetic sensors indicating the magnetic field at each of the magnetic sensors with a web server running on the controller for initialization and configuration of controller parameters, a transmitter transmitting the digital data and unique identifiers from the controller to a local area network and thence to a remote processor, where the processor determines a position of the permanent magnet on the gauge based on the digital data and the unique identifier of each magnetic sensor.

A remote level sensor system for a fuel oil tank including a gauge with a permanent magnet which changes positions along a first axis with changes in the level of oil in the tank in accordance with an embodiment of the present disclosure includes a plurality of magnetic sensors positioned in an array and attached to the gauge, each magnetic sensor of the plurality of magnetic sensors generating a continuous voltage under the influence of a magnetic field from the permanent magnet when the permanent magnet is within the sensitivity range of a particular magnetic sensor or subset of the plurality of the magnetic sensors, a connector to electronically connect each magnetic sensor to a separate controller, a connecting electronic cable that connects the connector to the separate controller which generates a unique identifier and digital data from analog voltage information provided from each magnetic sensor and includes a web server for initialization and configuration of controller parameters, a transmitter by which the digital data and unique identifiers from the controller are transmitted to a local area network and thence to a remote website processor wherein the processor determines the position of the permanent magnet using the digital data by choosing a peak value and interpolating between said peak and the next lowest value.

A method of determining a fuel oil level in a fuel oil tank having a gauge with a permanent magnet which changes positions along a first axis with changes in the level of oil in the tank comprises providing a plurality of magnetic sensors along a length of the gauge; periodically sampling an output of each of the magnetic sensors, the output indicating a magnetic field sensed at the respective magnetic sensor; generating a unique identifier for each of the magnetic sensors and digital data indicating the output of the respective magnetic sensor; transmitting the digital data and unique identifier to a processor; determining a remaining fuel level in the oil tank based on the digital data and the unique identifier; and providing an alert signal when the remaining fuel level is below a predetermined threshold level.

Other features and advantages of the present invention will become apparent from the following description of the invention, which refers to the accompanying drawings.

### BRIEF DESCRIPTION OF THE DRAWINGS

For a more complete understanding of the invention, reference is made to the following description and accompanying drawings, in which:

FIG. 1 illustrates an exemplary electrical schematic of a fuel oil level sensor in accordance with an embodiment of the present disclosure;

FIG. 2 illustrates an exemplary flow chart for reading a fuel level using the fuel oil level sensor of FIG. 1 in accordance with an embodiment of the present disclosure.

FIG. 3 illustrates an exemplary flow chart illustrating steps to maintain a fuel delivery system including the fuel oil level sensor of FIG. 1 in accordance with an embodiment of the present disclosure; and

FIG. 4 illustrates an exemplary embodiment of magnet position interpolation used to determine a fuel oil level disclosure.

FIG. 5 illustrates an exemplary block diagram of a system for monitoring a fuel oil level using the fuel oil level sensor of FIG. 1 in accordance with an embodiment of the present disclosure.

### DETAILED DESCRIPTION OF THE EMBODIMENTS

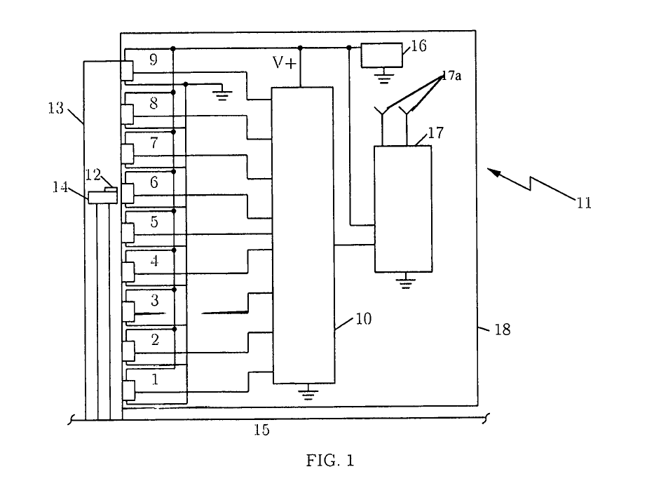

The arrangement in FIG. 1 shows a preferred embodiment of a fuel level sensor [11]. FIG. 1, also illustrates a controller [10] and a plurality of magnetic sensors S1 [1], S2 [2], S3 [3], S4 [4], S5 [5], S6 [6], S7 [7], S8 [8] and S9 [9] which provide voltage signals to the controller [10]. The controller [10], the level indicator [14] and gauge [13] are preferably embodied as an integral assembled remote fuel level sensor [11] that mounts to a fuel oil tank [15] (partially shown) in a standard fashion.

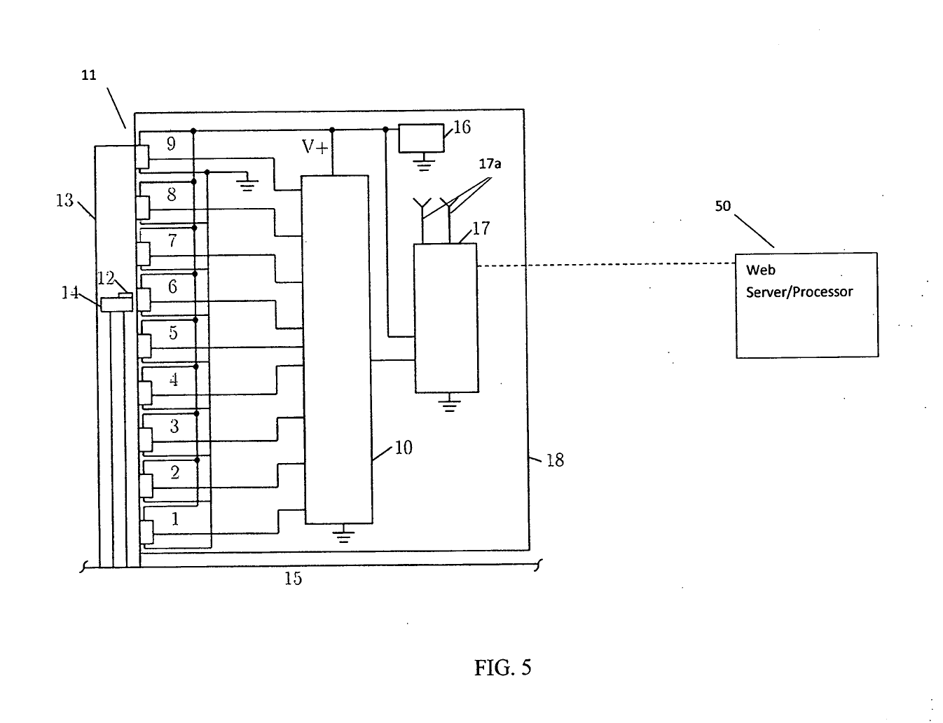

A changing level of fuel oil in the tank causes a change in position of the level indicator [14] within the gauge [13]. The level indicator [14] is preferably part of a level sensing mechanism which is commonplace in existing residential fuel oil tanks. As the level of oil in the tank drops, the vertical position of the level indicator [14] drops proportionately. A permanent magnet [12] is preferably located on top of the level indicator [14], and moves with it. The relative location of the magnet [12] is detected by the remote sensing device [11], and is used as an indication of the level of fuel oil in the tank. As can be seen in FIG. 5, for example, the sensing device 11 preferably transmits data to a remote website processor 50, via the transmitter [17], for example. In a preferred embodiment, the transmitter [17] communicates with the processor [50] via a local area network (LAN) and the Internet. The processor [50] preferably determines a fuel oil level left in the tank and provides alert messages as necessary to the fuel oil supplier to arrange for deliveries. The processor [50] preferably also maintains current fuel oil level information and may display it on a website that is accessible by the customer and supplier. In an embodiment, the sensing device 11 may include a processor [50] for a website which functions in substantially the same manner as described above and as detailed below.

The electrical components of the remote sensing device [11] are shown in FIG. 1 in block diagram form. Those skilled in the art will recognize that the hybrid format of FIG. 1 is for descriptive purposes.

Contained within the device housing [18] of the remote sensing device [11] is a controller [10], which controls operation of the device 11. The controller [10] may be of known design, but preferably makes use of low-cost, low-power components, such as the ACKme Networks AMW006 (Numbat) module. The Numbat module also has an embedded processor, a scheduler, analog to digital converters, a web server and a WiFi radio or transmitter which are used in the preferred embodiment of the invention. While the ACKme Networks AMW006 (Numbat) module is preferred, any suitable control element, or elements may be used.

In a preferred embodiment, nine Hall effect magnetic sensors S1 [1], S2 [2], S3 [3], S4 [4], S5 [5], S6 [6], S7 [7], S8 [8], S9 [9] are preferably located in the device housing [18] of the remote sensing device [11] along the length of and in close proximity to the cylindrical gauge [13]. In a preferred embodiment, all of the magnetic sensors (S1 [1], S2 [2], S3 [3], S4 [4], S5 [5], S6 [6], S7 [7], S8 [8], S9 [9]) are oriented similarly so that their responses to a magnetic field are of uniform polarities. The output responses or values of the Hall effect magnetic sensors are preferably converted to digital values when the controller [10] issues a command to scan the analog its inputs. The controller [10] preferably also generates a unique identifier for each of the sensors. The scanning preferably occurs at set intervals of time and the transmission of the scanned values to a remote website, or other processor, occurs thereafter. At the remote website, analysis of the scanned values indicates the fuel oil level present at the time of the scan. While the present disclosure discusses the use of Hall effect magnetic sensors, any suitable magnetic sensor may be used. A unique identifier may also be used to identify the tank 15, if desired.

The controller [10] preferably operates in a low power mode until the transmission of the sensor level data, at which time it powers on the transmitter [17] for the brief time it takes to transmit the data. The scan of the controller's input ports preferably occurs when a 16-bit seconds timer “rolls over” in order to minimize power consumption. This period of 65535 seconds corresponds roughly to 18 hours, yielding a slightly more frequent than daily reading. In the preferred embodiment, the transmission is via HTTP, but a UDP transmission protocol is also available in the AMW006 Numbat and may be used.

The use by the controller [10] of a low power mode and a timer initiated transmission conserves battery power. While the preferred embodiment uses a wake timer which initiates a sampling routine every 65535 seconds, those skilled in the art will recognize that this time interval may be somewhat longer or shorter without significantly affecting the performance of the remote sensing device [11].

The IEEE 802.11 protocol functions and internet connectivity of the remote sensing device [11] are preferably provided by the controller [10]. The transmitter 17, or other radio, is preferably connected to a local area network and may include antennas [17a] mounted internally in the device housing [18]. In this preferred embodiment, internal mounting also serves to protect the antennas [17a] from the environment, but external antennas may substitute for the internal ones to increase radio range or directionality.

The magnetic field near the end of a cylindrical permanent magnet, such as the permanent magnet [12] approximates the field of a current loop that would give rise to the same field strength. At a distance r from the end of the magnet, where r is much greater than the radius of the cylindrical magnet, the mathematical form of such a magnetic dipole field is:

Bᵣ=μ₀M₀ cos θ/r³,

B_{θ}=½μ₀M₀ sin θ/r³,

where M₀ is the effective magnetic moment at the surface of the magnet, θ is the angle from the normal to the magnet face and r is the distance from the center of the magnet face. The magnetic field seen by a particular sensor from a magnet at position rₘ and angle θₘ is the vector sum of these two components:

$$\begin{matrix}{B}_{m} = {B}_{r} cos {θ}_{m} + {B}_{θ} sin {θ}_{m} & ( 2 ) \\ or & \\ {B}_{m} = \frac{{μ}_{0} {M}_{0}}{{r}_{m}^{3}} ( {cos}^{2} {θ}_{m} + \frac{1}{2} {sin}^{2} {θ}_{m} ) = \frac{{μ}_{0} {M}_{0}}{{r}_{m}^{3}} ( 1 - \frac{1}{2} {sin}^{2} {θ}_{m} ) . & ( 3 )\end{matrix}$$

Since the horizontal distance, dₓ, from the face of the magnet to the plane of the sensors is constant, there is the further constraint:

dₓ²+d_{y}²=rₘ²,

or, alternatively:

d_{y}=rₘ sin θₘ.

The ultimate equation for the magnetic field at a given distance reduces to an equation for the field at a given vertical distance, d_{y}, from the sensor:

$${B}_{m} = \frac{{μ}_{0} {M}_{0}}{{r}_{m}^{3}} ( \frac{{d}_{x}^{2} + {d}_{y}^{2}}{{r}_{m}^{2}} - \frac{{d}_{y}^{2}}{2 {r}_{m}^{2}} ) = \frac{{μ}_{0} {M}_{0}}{2} \frac{2 {d}_{x}^{2} + {d}_{y}^{2}}{{( {d}_{x}^{2} + {d}_{y}^{2} )}^{3}} . \qquad ( 4 )$$

Equation(4) describes a magnetic field sharply peaked at the position of the sensor. On either side of the sensor, the field decays rapidly but still remains within the sensitivity range of an adjacent detector. Either direct reading of a maximum sensor output or interpolation of two adjacent detectors' outputs provides resolution of the position of the indicator along the first axis. Equation(4) maybe used to determine the position of the permanent magnet [12].

The remote hosting website, or processor [50] thereof, produces a fuel level calculation once it receives the data from the remote sensing device [11] regarding the magnetic field. In a typical calculation of the fuel level, nine Hall effect sensors are positioned at equidistant positions along the gauge cylinder [13], which corresponds to one sensor every 10% of height along the cylinder, ignoring positions along the cylinder at 0% and 100% as unnecessary. Fewer or additional magnetic sensors may be used, if desired. Each Hall effect sensor preferably connects to an analog input on the controller [10] in one-to-one correspondence. The controller [10] scans all its analog input channels sequentially and preferably converts these nine input voltages to nine digital values, each value corresponding to the magnetic field seen or sensed by the respective sensor from the permanent magnet [12]. In a typical exemplary embodiment, a Texas Instruments DRV5053-EA Hall Effect sensor generates 45 mV/mT, with the output ranging from 2.0 Volts at 22.2 mT of the South magnetic field to 0.0V at 22.2 mT of the North magnetic field. At zero magnetic field, the output of the Hall sensor is 1.00V. With a magnet of 7300 mT face magnetization positioned so that only the South magnetic field faces the sensors, voltages from the sensors range from 1.00V to 2.00V. In an embodiment, the controller [10] converts these voltages to digital numbers between 2048 and 4096. There are only three distinct classes of values that the controller [10] might transmit:
1. all sensors are within a few digits of 2048, indicating no magnet at all;
2. one sensor is nearly at 4096 and all the others are near 2048, indicating a magnet directly over a sensor;
3. two sensors have relatively high readings and all the others are near 2048, indicating a magnet somewhere between the positions of the two sensors.

The controller [10] thus uploads, or transmits, in an embodiment of the invention, an array of numerical values with nine array elements, each one having a value between 2048 and 4096, indicative of the magnetic field sensed at each of the sensors 1-9. At the hosting website, processor [50] runs a software program and reads the array of values and determines which of the three classes of measurements discussed above it has just received. If it has received an array of values consistent with Case 1 above, the processor [50] indicates an error, since there should be a magnet somewhere in the proposed embodiment. If it has received an array of magnetic sensor values consistent with Case 2, the processor converts the array index of the sensor data to identify the particular sensor of the sensors 1-9 corresponding to the high reading to correspond to the position of the permanent magnet [12], since the positions of the Hall sensors are known to be at increments of 10% of the cylinder height. If it has received an array of data consistent with Case 3, the processor [50] calculates a fit to equation 4 using the readings from the two adjacent sensors. From the fit to the form of the magnetic field, the processor [50] extracts the position of the maximum, which is the position of the permanent magnet [12] between the two sensors.

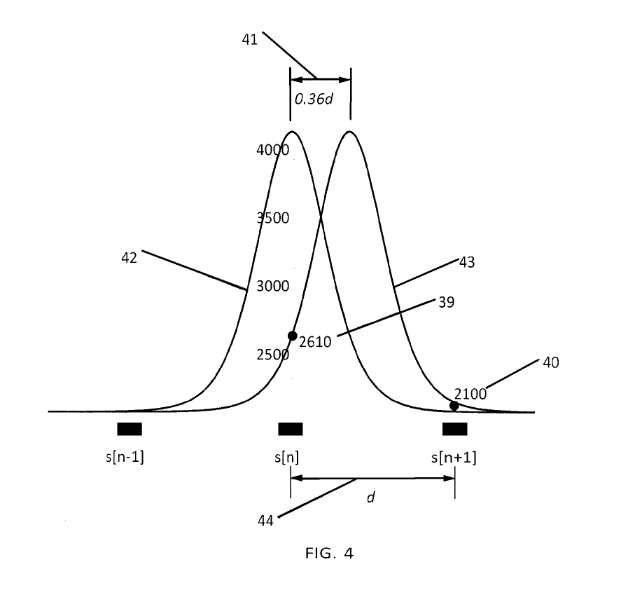

FIG. 4 is the result of a sample calculation. If the magnet is directly over the position of a sensor s[n] [39], indicated by the centered magnetic field [42] the result is consistent with Case 2 above, namely that the sensor s[n] [39] will cause the controller [10] to upload to the website and processor [50] a count of approximately 4096. The website processor [50] then converts this position to gallons of fluid by means of a nomograph or chart specific to the given tank geometry. Tanks are of a given set of sizes and shapes and each gauge in the proposed invention is matched by database to the geometry of the tank it is monitoring.

In the case where a magnet lies between two sensors, the value [43] is typical of the magnetic field seen by the sensors. On this graph, the value at s[n] [39] and the value at s[n+1] [40] are the inputs to a least squares routine that performs a fit to the function in Equation(4). The least squares fit is a standard technique of those practiced in the art and the result of the fit to Equation(4) yields the lsfit [41] to the Equation(4) by finding a good value for the position of the maximum of the value [43] relative to the position of s[n] [39] as a fraction of the pitch [44] between the sensors. As in the previous calculation, the website determines the gallons of fluid from a chart or nomograph, given the tank shape and orientation, which are predetermined and stored in a memory associated with or included in the processor [50].

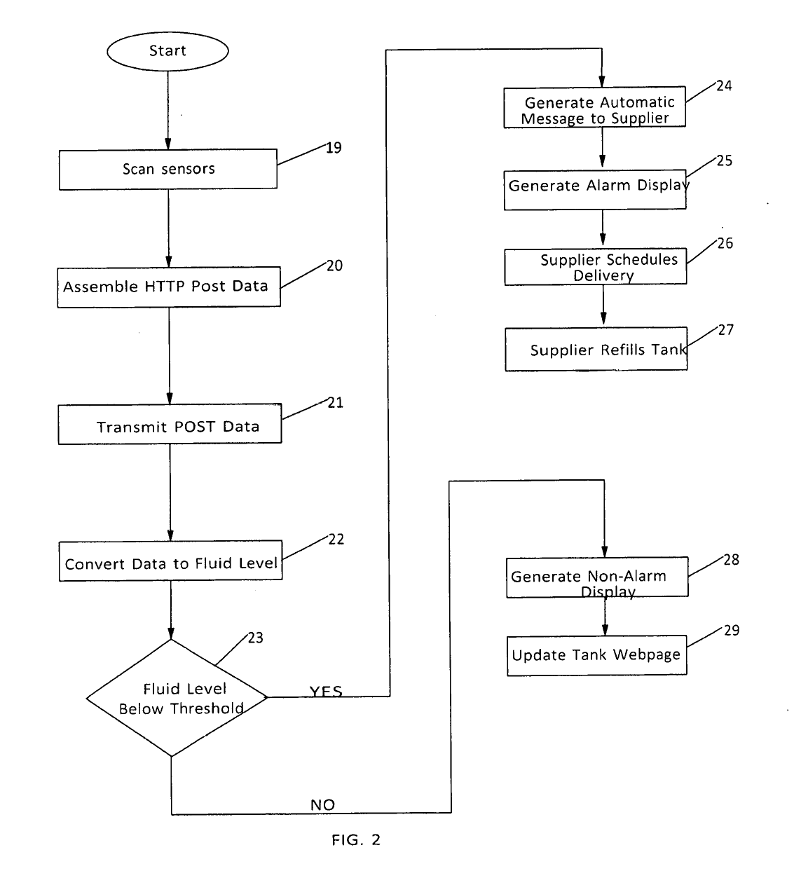

FIG. 2 is an exemplary flow chart indicating steps leading to the delivery of fuel oil using the fuel level sensing device [11] according to the present invention. In a first step [19], the controller [10] preferably initiates a scan of all the analog to digital channels (inputs) thereof, which are connected to the sensors 1-9 discussed above. In a second step [20], the controller [10] converts the voltages from the Hall Effect sensors to digital values. In a third step [21], the controller [10] transmits formatted data to the remote website processor [50] indicative of the scanned values for each of the sensors 1-9 with identification information for each sensor. In the envisioned implementation, this formatting is in JSON format, a format known to those practiced in the art, however, other formats may be used. In the next step [22], the website employs software to convert the digital values to fluid levels. In the proposed implementation, the computer language PHP performs the calculation, however, any suitable language may be used. At the next step [23], the processor [0] compares the fuel oil level to a preset alarm threshold. If the fluid level is below the threshold, at the next step [24] the website processor [50] initiates an automatic message to the supplier, which may be a phone call, a text message, or other electronic communication. In addition, at step [25], the website processor [50] generates an alarm display of particular configuration for posting on the website. In step [26], the supplier reacts to the message of step [24]. In step [27], the supplier fills the tank to complete the delivery. If the conditional test in step [23] is false, that is, the fluid level is not below the threshold, the website processor [50] continues to step [28] and generates data for the indication of the current fluid level. In step [29], the website updates the website display with the new fluid level. Thus, the current fuel oil level is viewable on the website, which may be accessed by the supplier, customer or other authorized party.

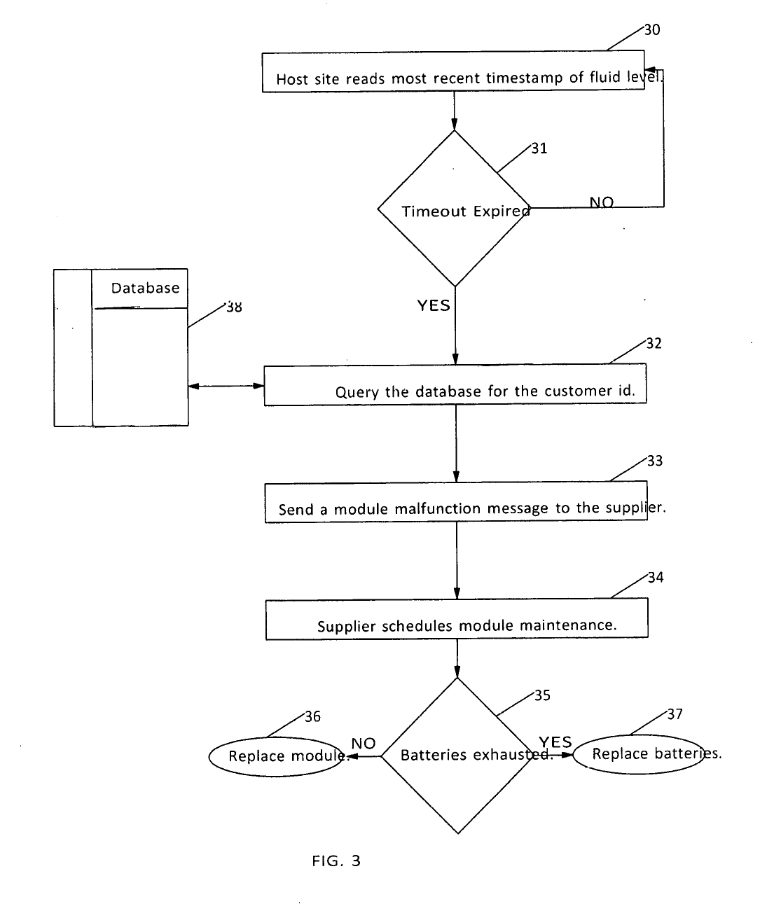

FIG. 3 is an exemplary flow chart indicating automatic detection of module failure or battery depletion according to the present invention. In step [30], the hosting website processor [50] reads the timestamp of the most recent update to the fluid level in the tank. If the time of the most recent fluid level update is older than the present time by a given preset number of hours, the conditional in step [31] causes a transition to step [32], in which the processor [50] performs a database query of database [38] to determine which fluid gauge is not updating. Once the identity of the gauge is known, in step [33] the processor [50] sends the supplier an automatic electronic malfunction message, which may be a phone call, a text message, or other electronic communication. As a result of the electronic communication in step [33], in step [34] the supplier schedules a maintenance visit. During the maintenance visit, if the result of conditional step [35] is true, in step [37] the maintenance technician replaces the dead batteries in the device. If the test in step 35 is false, in step [36], the technician replaces the malfunctioning device.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

A remote level sensor for a fuel oil tank having a gauge with a permanent magnet which changes positions along a first axis with changes in the level of oil in the tank in accordance with an embodiment of the present disclosure includes a housing, a plurality of magnetic sensors located in the housing which generate continuous voltages under the influence of a magnetic field from the magnet when the magnet is within the sensitivity range of a particular subset of the plurality of sensors, a controller for generating a unique identifier and digital data from analog voltage outputs of magnetic sensors, a web server running on the controller for initialization and configuration of controller parameters, a radio by which the data from the controller is transmitted to a local area network and thence to a remote website, and an algorithm by which the position of the magnet can be imputed by choosing the peak value of the set of values transmitted to the remote web site and interpolating between said peak and the next lowest value, thereby estimating the magnet position with respect to the sensor positions.

The remote level sensor may include a WiFi radio which connects to a LAN and which transmits data to a remote website for analysis.

The radio may include a Bluetooth® radio which connects to a paired Bluetooth® remote radio and which transmits data to the remote radio.

The remote level sensor may include a battery power source which establishes a voltage node and provides power to the sensors, controller and radio.

The power source may include an AC to DC converter which establishes a voltage node from AC line power.

The remote level sensor may include a controller which creates data to enable a remote, automatically piloted vehicle to provide tank refills.

The remote level sensor may include a push-button to enable automated setup of the connection to the internet.

The remote level sensor may include a controller which contains a web server to implement a user interface to its configuration variable and parameters.

A remote level sensor for a fuel oil tank having a gauge with a permanent magnet which changes positions along a first axis with changes in the level of oil in the tank in accordance with an embodiment of the present disclosure includes a housing separate from the indicator gauge which conforms to the cylindrical gauge and attaches securely by means of cable ties or pipe clamps, a plurality of magnetic sensors located in the housing which generate continuous voltages under the influence of a magnetic field from the magnet when the magnet is within the sensitivity range of a particular subset of the plurality of sensors, a controller for generating a unique identifier and digital data from analog voltage outputs of magnetic sensors, a web server running on the controller for initialization and configuration of controller parameters a radio by which the data from the controller is transmitted to a local area network and thence to a remote website, and an algorithm by which the position of the magnet is imputed by choosing the peak value of the set of values transmitted to the remote website and interpolating between said peak and the next lowest value, thereby estimating the magnet position with respect to the sensor positions.

A remote level sensor for a fuel oil tank having a gauge with a permanent magnet which changes positions along a first axis with changes with the level of oil in the tank in accordance with an embodiment of the present disclosure includes a housing separate from the indicator gauge which slips over the cylindrical gauge via a matching cylindrical hole with tolerances close enough to form a non-rotating attachment, a plurality of magnetic sensors located in the housing which generate continuous voltages under the influence of a magnetic field from the magnet when the magnet is within the sensitivity range of a particular subset of the plurality of sensors, a controller for generating a unique identifier and digital data from analog voltage outputs of magnetic sensors, a web server running on the controller for initialization and configuration of controller parameters, a radio by which the data from the controller is transmitted to a local area network and thence to a remote website, and an algorithm by which the position of the magnet can be imputed by choosing the peak value of the set of values transmitted to the remote web site and interpolating between said peak and the next lowest value, thereby estimating the magnet position with respect to the sensor positions.

The permanent magnet may have its poles arranged parallel to the array of magnetic sensors.

A remote level sensor for a fuel oil tank having a gauge with a permanent magnet which changes positions along a first axis with changes in the level of oil in the tank in accordance with an embodiment of the present disclosure includes a housing separate from the indicator gauge, a plurality of magnetic sensors in an array attached to the indicator gauge with adhesive or other means of permanent attachment, which generate continuous voltages under the influence of a magnetic field from the magnet when the magnet is within the sensitivity range of a particular subset of the plurality of sensors, a connector to electronically connect the magnetic sensor array to a separate controller, a connecting electronic cable that connects the sensor array to a separate controller by means of a connector, a connector on the controller that mates with the cable from the sensor array; a controller for generating a unique identifier and digital data from analog voltage outputs of magnetic sensors, a web server running on the controller for initialization and configuration of controller parameters a radio by which the data from the controller is transmitted to a local area network and thence to a remote website, and an algorithm by which the position of the magnet is imputed by choosing the peak value of the set of values transmitted to the remote website and interpolating between said peak and the next lowest value, thereby estimating the magnet position with respect to the sensor positions.

Although the present invention has been described in relation to particular embodiments thereof, many other variations and modifications and other uses will become apparent to those skilled in the art.

What is claimed is:

1. A remote level sensor system for a fuel oil tank including
a gauge with a permanent magnet that changes position based on a fuel oil level in the fuel oil tank comprising:
a housing separate from the gauge and attached thereto;
a plurality of magnetic sensors mounted on the gauge, each magnetic sensor of the plurality of magnetic sensors positioned at predetermined position on the gauge relative to the other magnetic sensors of the plurality of sensors and configured to provide information indicating magnetic field at the respective location thereof;
a controller connected to each magnetic sensor of the plurality of magnetic sensors and configured to receive information regarding the magnetic field from each of the plurality of magnetic sensors and to generate a unique identifier for each one of the plurality of magnetic sensors;
a transmitter connected to the controller and configured to send the information regarding the magnetic field from each of the plurality of magnetic sensors with the unique identifier for the respective magnetic sensor; and
a processor that receives the data from the transmitter and determines a position of the permanent magnet on the gauge and provides an indication of the remaining fuel oil in the tank based thereon.

2. The remote level sensor system of claim 1 wherein the processor issues an alert signal when the remaining fuel oil is below a predetermined threshold.

3. The remote level sensor system of claim 2, wherein the alert signal is transmitted to a user to notify them of the remaining fuel oil in the tank.

4. The remote level sensor system according to claim 1, wherein the transmitter is a WiFi radio that is in communication with a local area network connected to the processor.

5. The remote level sensor system of claim 1, wherein the processor is associated with a remote Internet website and the alert signal is used to display an alert indication on the remote Internet website.

6. The remote level sensor system of claim 1, wherein the transmitter is a Bluetooth® radio which connects to a paired Bluetooth® remote radio and which transmits data to the processor.

7. The remote level sensor system of claim 1, further comprising a battery to provide power to at least the plurality of magnetic sensors, the controller and the transmitter.

8. The remote level sensor system of claim 1, further comprising a power source including an AC-DC converter to provide power to at least the plurality of magnetic sensors, the controller and the transmitter from an AC line voltage.

9. The remote level sensor system of claim 1, wherein the controller further generates location data to enable a remote, automatically piloted vehicle to locate the oil tank to provide tank refills.

10. The remote level sensor system of claim 1, further comprising an input device configured to automate setup of the connection of the transmitter to the processor.

11. The remote level sensor system of claim 1, wherein the processor includes a web server to implement a user interface to provide its configuration variables and parameters.

12. A remote level sensor system for a fuel oil tank including a gauge with a permanent magnet which changes positions along a first axis with changes in the level of oil in the tank comprises:
a housing separate from the gauge which attaches securely to the gauge,
a plurality of magnetic sensors located in the housing, each magnetic sensor of the plurality of magnetic sensors positioned at predetermined position relative to the gauge and generating continuous voltages under the influence of a magnetic field from the permanent magnet when the magnet is within the sensitivity range of a particular magnetic sensor of subset of the plurality of magnetic sensors,
a controller connected to the plurality of magnetic sensors receiving the continuous voltage information and generating a unique identifier for each magnetic sensor as well as digital data based on the continuous voltage information and the unique identified associated with the and including a web server running on the controller providing for initialization and configuration of controller parameters; and
a transmitter connected to the controller and configured to transmit the digital data including the unique identifier associated therewith to a local area network and thence to a processor of a remote web site, wherein
the processor that determines a position of the permanent magnet based on the digital data and the unique identifier to estimate the magnet position with respect to the magnetic sensor positions.

12. The remote level sensor system of claim 11, wherein the processor determines the position of the permanent magnet by determining whether the digital data indicates a peak magnetic field associated with any one of the plurality of magnetic sensors.

13. The remote level sensor system of claim 11, wherein the processor determines the position of the permanent magnet by interpolating based on the two highest magnetic field readings indicated by the digital data and the magnetic sensors associated therewith when no peak is indicated by the digital data associated with any one of the plurality of magnetic sensors.

14. A remote level sensor system for a fuel oil tank having a gauge with a permanent magnet which changes positions along a first axis with changes with the level of oil in the tank comprises:
a housing separate from the gauge which slips over the gauge, the housing including a cylindrical hole through which the gauge passes,
a plurality of magnetic sensors located in the housing each magnetic sensor of the plurality of magnetic sensors positioned at predetermined position relative to the gauge and generating continuous voltages under the influence of a magnetic field from the permanent magnet when the magnet is within the sensitivity range of a particular magnetic sensor of subset of the plurality of magnetic sensors,
a controller for generating a unique identifier and digital data from analog voltage outputs of each of the magnetic sensors indicating the magnetic field at each of the magnetic sensors with a web server running on the controller for initialization and configuration of controller parameters, and
a transmitter transmitting the digital data and unique identifiers from the controller to a local area network and thence to a remote processor,
where the remote processor determines a position of the permanent magnet on the gauge based on the digital data and the unique identifier of each magnetic sensor.

15. The remote level sensor system of claim 14, wherein the permanent plurality of magnetic sensors are positioned such that they are parallel to the poles of the permanent magnet.

16. A remote level sensor system for a fuel oil tank having a gauge with a permanent magnet which changes positions along a first axis with changes in the level of oil in the tank comprises
a plurality of magnetic sensors positioned in an array and attached to the gauge, each magnetic sensor of the plurality of magnetic sensors generating a continuous voltage under the influence of a magnetic field from the permanent magnet when the permanent magnet is within the sensitivity range of a particular magnetic sensor or subset of the plurality of the magnetic sensors,
a connector to electronically connect each magnetic sensor to a separate controller,
a connecting electronic cable that connects the connector to the separate controller which generates a unique identifier and digital data from analog voltage information provided from each magnetic sensor and includes a web server for initialization and configuration of controller parameters; and
a transmitter by which the digital data and unique identifiers from the controller are transmitted to a local area network and thence to a remote website processor, wherein
the processor determines the position of the permanent magnet using the digital data by choosing a peak value and interpolating between said peak and the next lowest value.

17. A method of determining a fuel oil level in a fuel oil tank having a gauge with a permanent magnet which changes positions along a first axis with changes in the level of oil in the tank comprises:
providing a plurality of magnetic sensors along a length of the gauge;
periodically sampling an output of each of the magnetic sensors, the output indicating a magnetic field sensed at the respective magnetic sensor;
generating a unique identifier for each of the magnetic sensors and digital data indicating the output of the respective magnetic sensor;
transmitting the digital data and unique identifier to a processor;
determining a remaining fuel level in the oil tank based on the digital data and the unique identifier; and
providing an alert signal when the remaining fuel level is below a predetermined threshold level.

18. The method of determining a fuel oil level of claim 17, further comprising storing the remaining fuel level.

19. The method of determining a fuel oil level of claim 17 further comprising displaying the remaining fuel oil level on a website.
